(19) United States
(12) Patent Application Publication
(10) Pub. No.: US 2008/0232283 A1
(43) Pub. Date: Sep. 25, 2008

(54) Method and Apparatus for Handling Random Access Procedure in a Wireless Communications System

(76) Inventor: Yu-Chih Jen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/053,522

(22) Filed: Mar. 21, 2008

Related U.S. Application Data
(60) Provisional application No. 60/895,987, filed on Mar. 21, 2007.

(51) Int. Cl. H04B 7/00

(52) U.S. Cl. 370/310

(57) ABSTRACT

A method for handling a random access procedure in a network of a wireless communications system comprises transmitting a downlink message comprising a special preamble identifier and other information of fields via addressing of a specific identifier for all UEs in a cell.

### CROSS REFERENCE TO RELATED APPLICATIONS

This application claims the benefit of U.S. Provisional Application No. 60/895,987, filed on Mar. 12, 2007 and entitled “Method and Apparatus to improve LTE Random access procedure”, the contents of which are incorporated herein by reference.

### BACKGROUND OF THE INVENTION

1. Field of the Invention

The present invention relates to a method and apparatus for handling random access procedure in a wireless communications system, and more particularly, to a method and apparatus for implementing timing alignment and resource request, so as to enhance system efficiency.

2. Description of the Prior Art

The third generation mobile telecommunications system (called 3G system) provides high frequency spectrum utilization, universal coverage, and high quality, high-speed multimedia data transmission, and also meets all kinds of QoS requirements simultaneously, providing diverse, flexible, two-way transmission services and better communication quality to reduce transmission interruption rates. However, due to demand for high-speed and multimedia applications, the next generation mobile telecommunications technology and related communication protocols have been developed.

In the Long Term Evolution wireless communications system (LTE system), a Random Access Channel (RACH) is configured in an uplink (UL) channel between a user equipment (UE) and the network, and utilized for timing alignment, RNTI (Radio Network Temporary Identifier) assignment, and resource request. In the starting state, only downlink (DL) timing between UE and Node B (NB) is synchronized, and signals on RACH can be used for UL timing alignment. Before performing UL timing alignment, UE uses downlink Synchronization Channel or reference signals to perform synchronization on timing and frame. However, since signals may be delayed due to a distance between the transmitter and receiver, UE is not able to determine whether a message transmitted from UE is at a starting position of a receiving frame of NB. In addition, when NB provides service for multiple UEs at the same time, Round Trip Delays (RTDs) between each UE and NB may be different due to different distances thereof, causing timing offset. Therefore, NB evaluates timing offset of a UE according to RACH signals from the UE, and notifies the UE to adjusting UL timing via Downlink Shared Channel (DL-SCH), to achieve timing synchronization. A RACH signal is composed of preambles used for UL timing synchronization and UE identity detection, or carrying short signaling or signature.

On the other hand, RACH signals among different UEs are transmitted to NB by contention-based or non-contention-based method. That is, UE can select a RACH transmission opportunity and randomly select a preamble to transmit signals, or transmit a signal carrying a preamble assigned by the network (in such a situation, the RACH transmission opportunity is assigned by the network or selected by the UE). If the network cannot identify the transmitted RACH signal due to collision or low power, or if contention lost occurs due to a randomly-selected preamble, the UE can retransmit the RACH signal with larger power in the next available RACH transmission opportunity, until a response from the network is received or a condition is reached, e.g., maximum transmitting or maximum power.

For LTE, a RACH transmission opportunity is related to a time-frequency radio resource, not only related to time or frequency. Therefore, when RACH physical resource is selected, its time period and frequency band are determined. Of course, at certain time period, there may be more than one frequency sub-band for selection. On the other hand, preamble can be random access preamble, which is randomly selected by UE, or dedicated preamble, which is assigned by network (source cell or target cell). Basically, when UE uses (randomly selected) random access preamble, there is possibility another UE use the same preamble and transmit it in the same RACH opportunity so that network doesn't know whether the signal comes from one or more than one UE. Consequently, contention exists and will be solved after UE sends its UE identity in subsequent message 3. In contrary, dedicated preamble is assigned by network to a known specific UE so it's unique and won't cause contention between UEs (no another UE use the same dedicated preamble.)

In LTE, asynchronous RACH is concluded and adopted as working assumption where dedicated preamble and random access preamble based RACH accesses may both be supported. Random access procedure performance mainly in terms of latency and overhead is affected by collision/contention probability, time/frequency resources, number of user equipments (load), number of preamble signature, channel quality, UE identities, and even access causes and so on. On the other hand, the design requirements in addition to performance, such as short life span of identity usage, to be common for various kinds of non-synchronous RACH accesses in E-UTRAN (eNB and aGW) for FDD and TDD as well as irrespective of cell size, optimization for connected state UEs, are considered while possible reasons for UE to access on RACH can be categorized into four main causes, which are initial access (e.g. UE originated call, network originated call, tracking area update and initial cell access) including initial NAS signaling for NAS procedures (e.g. service request, network attach, routing/tracking area update), synchronization request, handover access and scheduling request. According to requirements and need of support for possible access causes, the baseline random access procedure model and channel mapping (between logical channels and transport channels) are defined in the prior art. Current decision on four steps of random access procedures is shown as following:

(1) Step “Random Access Preamble on RACH in uplink”: is corresponding to a message 1, which carries 6 bits, and indicates a random ID, and possibly other information, e.g., cause or size, potentially with priority, pathloss or CQI to allocate UL resource appropriately.

(2) Step “Random Access Response on DL-SCH”: is corresponding to a message 2, which is semi-synchronous (within a flexible window of which the size is one or more TTI) with message 1, no HARQ (Hybrid Automatic Repeat Request) support, transmitted on L1/L2+DL-SCH, addressed to RA-RNTI (Random Access RNTI) on L1/L2 control channel, conveys at least RA-preamble identifier, timing alignment information, initial UL grant and assignment of Temporary Cell RNTI (T-CRNTI), and is intended for one or multiple UEs in one DL-SCH message.

(3) Step “First scheduled UL transmission on UL-SCH”: is corresponding to a message 3, which uses HARQ, operates in RLC TM (Radio Link Control Transparent Mode) without segmentation, conveys at least UE identifier and (explicit or implicit) information on whether C-RNTI is already available. Besides, in case of initial access and if the size of the message allows it, the initial NAS message (or something allowing to build the initial NAS message in eNB) can be included, and size of the message is dynamic.

(4) Step “Contention Resolution on DL-SCH”: is corresponding to a message 4, which is not synchronized with message 3, and addressed to the Temporary C-RNTI on L1/L2 control channel (at least for initial access). Besides, content of the message is FFS (for further study), HARQ is supported, and HARQ feedback is transmitted only by the UE which detects its own UE identity, as provided in message 3, echoed in the RRC (Radio Resource Control) Contention Resolution message.

In the prior art, at initial access, the four steps are: Random Access Preamble on RACH, Random Access Response via CCCH (Common Control Channel) on DL-SCH, RRC Connection Request via CCCH on UL-SCH, and RRC Contention Resolution via DCCH on DL-SCH.

Therefore, for LTE, the prior art provides steps of RA procedure. However, some problems may occur.

It's known that saving more bits on message 2 will increase access availability (e.g. more UE access information provided). However, similar information (e.g. preamble identifier, timing alignment information, initial access grant, and temporary C-RNTI) for each intended UE in message 2 is inefficiently provided. For, complete information for each UE must be provided every time accessing RACH.

There are several reasons to trigger random access procedures or RACH access. It's considered to use TMSI as UE identity provided in message 3 for contention resolution. However, it will consume 32 bits on the UL-SCH for each accessing UE. Shorter UE identity can be considered. On the other hand, TMSI may not be valid due to changing to tracking area (TA) so that UE may not be uniquely identified in new TA, especially when the message of accessing cause is not time critical. Consequently, different kinds of UE identities are required to uniquely identify UE in distinct random access situation, which may confuse network if it's not specified. In case of TA change, using TA ID and TMSI together to identify a UE is not efficient for radio resource usage (e.g. consuming too many bits for unique ID). In addition, UE behavior is not specified when change of TA is detected. To make proper decision when detecting old TA's TMSI, it's necessary to allow new TA of a cell to know more information (e.g. exactly which old TA is) and cope with this kind of situation.

During random access procedure for initial access, TMSI was considered to be used as UE identity in message 3. However, TMSI may be invalid in the current tracking area (TA) since it has not been updated (e.g. during attach request or tracking area update). Of course, the need of updating TMSI may happen during random access procedures of other purposes. In case of the situations, it's considered to allow UE to use TMSI itself (e.g. may collide with another UE), TMSI and flag (e.g. flag indicate whether this is an old TMSI or not), or a random number (e.g. may essentially also jeopardize and collide with another UE). It's not convinced how the UE and network should deal with the issue under the assumption that full TA ID should not be used with TMSI since it requires too many bits.

For a UE detecting tracking area change, if additional information (e.g. other than 32-bit TMSI) cannot be used along with known invalid TMSI for the UE, the UE can only send invalid TMSI or random number. In case of collision, it may jeopardize UEs with valid TMSI issued in the current TA.

Message 3 includes UE identity, message size, and message content (e.g. RRC connection setup for initial access or NAS message content for NAS signaling procedure) and so on. There are various types of messages, and some of them may have more than one possible distinct signaling protocol (e.g. RRC or MAC or NAS) mapping according to triggers of the procedure. In addition, during random access procedure (e.g. initiate for NAS procedure), message 3 content is not fully scheduled to accelerate the procedure or reduce effects. (26)

Message 4 as contention resolution message is not fully utilized so that an UE “winner” can be delayed until completion of contention resolution for random access procedure of various causes. In addition, with different need on content of message 4, the message 4 should be fully utilized to save contention for a UE loser. On the other hand, it's only specified that T-CRNTI be used to address to UE on L1/L2 control channel.

It's possible for network to assign T-CRNTIs for a particular group of UEs. In this case, there is no need to assign a whole T-CRNTI to each UE in the group according to the number of UEs in the group. Consequently, it's unnecessary to use a whole T-CRNTI to address message 4 for each UE. Otherwise, the radio resources are unnecessarily consumed and the number of possible allowed access for random access procedure is reduced.

### SUMMARY OF THE INVENTION

According to the claimed invention, a method for handling a random access procedure in a network of a wireless communications system comprises transmitting a downlink message comprising a special preamble identifier and other information of fields via addressing of a specific identifier for all UEs in a cell.

According to the claimed invention, a method for handling a random access procedure in a user equipment, called UE hereinafter, of a wireless communications system comprises stopping the random access procedure when detecting tracking area change during the random access procedure; indicating to the network its UE identity and additional information in an uplink message; or indicating to the network about its C-RNTI and additional information in an uplink message.

According to the claimed invention, a method for handling a random access procedure in a user equipment, called UE hereinafter, of a wireless communications system comprises when a message 3 comprises a first UE identity and a first UE identity type message, expecting to detect a second UE identity and a second UE identity type message in a message corresponding to the message 3; wherein the first UE identity and the second UE identity are of different formats or sizes or same format or size; and wherein the first UE identity type message and the second UE identity type message are of different formats or sizes or same format or size.

According to the claimed invention, a method for handling a random access procedure in a network of a wireless communications system comprises assigning a primary and a secondary T-CRNTIs to each intended UE in message 2; and when the network is indicated or detects that another UE with the same UE identity, using the primary T-CRNTI to address a message 4 for valid UE identity and using the secondary T-CRNTI to address a message 4 for invalid UE identity with a new assigned UE identity.

According to the claimed invention, a method for handling a random access procedure in a user equipment, called UE hereinafter, of a wireless communications system comprises including a UE identity and an index to network in an uplink message when detecting tracking area change.

According to the claimed invention, a method for handling a random access procedure in a user equipment, called UE hereinafter, of a wireless communications system comprises comprising a UE identity chosen from a pool or a list of reserved UE identities in an uplink message to a network when detecting tracking area change.

According to the claimed invention, a method for handling a random access procedure in a user equipment, called UE hereinafter, of a wireless communications system comprises sending a message 3 comprising or with indication of signaling protocol index or message type to a network during the random access procedure.

According to the claimed invention, a method for handling a random access procedure in a user equipment, called UE hereinafter, of a wireless communications system comprises sending a message 3 comprising messages or signaling from one or more protocol layer to a network during random access procedure if enough uplink grant is sufficient.

According to the claimed invention, a method for handling a random access procedure in a network of a wireless communications system comprises sending a message 4 comprising messages or signaling from one or more protocol layer to a UE if downlink resource is sufficient.

According to the claimed invention, a method for handling a random access procedure in a network of a wireless communications system comprises transmitting a specified message or information to a UE when or after transmitting a contention resolution message during the random access procedure.

According to the claimed invention, a method for handling a random access procedure in a network of a wireless communications system comprises assigning a special T-CRNTIs and or with group index or resource partition, or consecutive normal T-CRNTIs, to a particular group of UEs according to standardized rules or configuration during random access procedure.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises transmitting a downlink message comprising a special preamble identifier and other information of fields via addressing of a specific identifier for all UEs in a cell.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises stopping the random access procedure when detecting tracking area change during the random access procedure; indicating to the network its UE identity and additional information in an uplink message; or indicating to the network about its C-RNTI and additional information in an uplink message.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises when a message 3 comprises a first UE identity and a first UE identity type message, expecting to detect a second UE identity and a second UE identity type message in a message corresponding to the message 3; wherein the first UE identity and the second UE identity are of different formats or sizes or same format or size; and wherein the first UE identity type message and the second UE identity type message are of different formats or sizes or same format or size.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises assigning a primary and a secondary T-CRNTIs to each intended UE in message 2; and when the network is indicated or detects that another UE with the same UE identity, using the primary T-CRNTI to address a message 4 for valid UE identity and using the secondary T-CRNTI to address a message 4 for invalid UE identity with a new assigned UE identity.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises including a UE identity and an index to network in an uplink message when detecting tracking area change.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises comprising a UE identity chosen from a pool or a list of reserved UE identities in an uplink message to a network when detecting tracking area change.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises sending a message 3 comprising or with indication of signaling protocol index or message type to a network during the random access procedure.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises sending a message 3 comprising messages or signaling from one or more protocol layer to a network during random access procedure if enough uplink grant is sufficient.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises sending a message 4 comprising messages or signaling from one or more protocol layer to a UE if downlink resource is sufficient.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises transmitting a specified message or information to a UE when or after transmitting a contention resolution message during the random access procedure.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises assigning a special T-CRNTIs and or with group index or resource partition, or consecutive normal T-CRNTIs, to a particular group of UEs according to standardized rules or configuration during random access procedure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 to FIG. 13 are flowcharts of processes according to embodiments of the present invention.

FIG. 14 is a schematic diagram of a wireless communications system.

### DETAILED DESCRIPTION

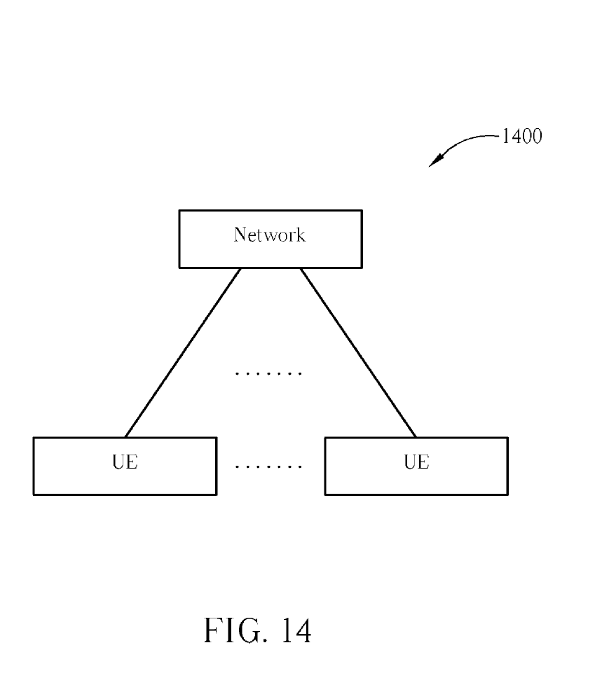

Please refer to FIG. 14, which illustrates a schematic diagram of a wireless communications system 1200. The wireless communications system 1400 is preferably an LTE system, and is briefly composed of a network and a plurality of UEs. In FIG. 14, the network and the UEs are simply utilized for illustrating the structure of the wireless communications system 1400. Practically, the network terminal may comprise a plurality of base stations (or Node B), radio network controllers and so on according to actual demands, and the UEs can be devices such as mobile phones, computer systems, etc.

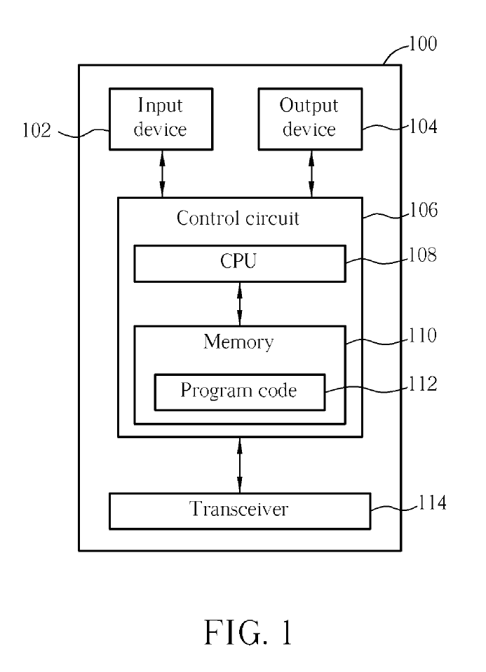

Please refer to FIG. 1, which is a functional block diagram of a communications device 100. The communications device 100 can be used for implementing the network and the UE shown in FIG. 14. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

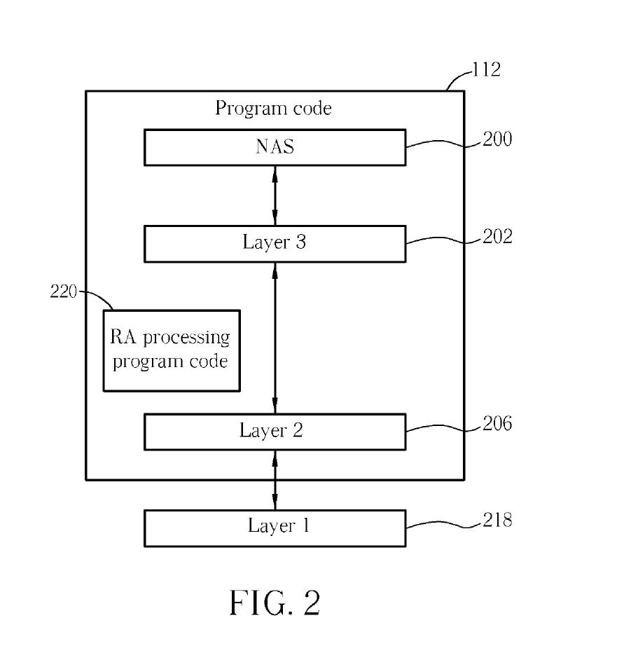

Please continue to refer to FIG. 2. FIG. 2 is a diagram of the program code 112 shown in FIG. 1. The program code 112 includes a Non Access Stratum (NAS) 200, a Layer 3 202, and a Layer 2 206, and is coupled to a Layer 1 218. The NAS 200 can generate NAS messages for realizing NAS applications. The Layer 3 202 is composed of an RRC layer, for performing radio resource control. The Layer 2 206 performs link control, and the Layer 1 218 performs physical connections. Whether a PDCP layer belongs to the Layer 3 202 or the Layer 2 206 is not relevant to this invention.

In order to achieve timing alignment and resource request, a RACH is configured in the communications device 100 for the random access procedure. In such a situation, the embodiment of the present invention provides a RA processing program code 220 for handling a random access procedure, so as to prevent the prior art problems. In the following, definitions of the messages 1, 2, 3, 4 are the same as what mentioned above. That is, the message 1 is corresponding to step “Random Access Preamble on RACH in uplink”, the message 2 is corresponding to step “Random Access Response on DL-SCH”, the message 3 is corresponding to step “First scheduled UL transmission on UL-SCH”, and the message 4 is corresponding to step “Contention Resolution on DL-SCH.”

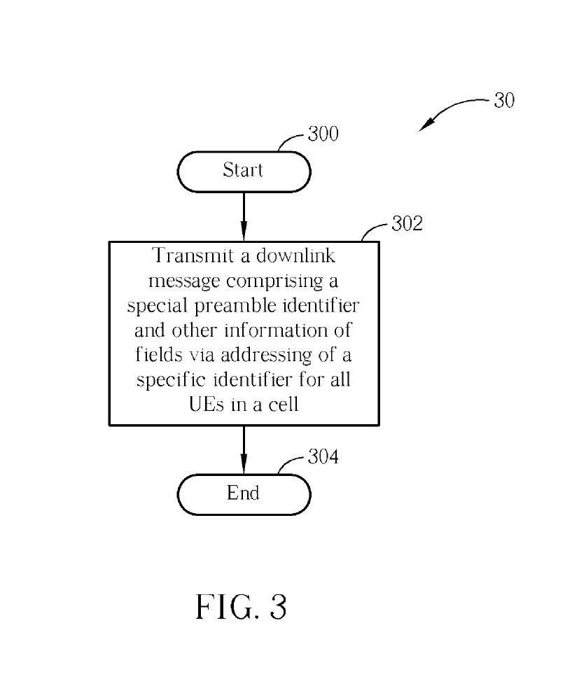

Please refer to FIG. 3, which illustrates a schematic diagram of a process 30 according an embodiment of the present invention. The process 30 is utilized for handling a random access procedure in a network of the wireless communications system 1400, and can be compiled into the RA processing program code 220. The process 30 comprises the following steps:

Step 300: Start.

Step 302: Transmit a downlink message comprising a special preamble identifier and other information of fields via addressing of a specific identifier for all UEs in a cell.

Step 304: End.

According to the process 30, the network can transmit a downlink message comprising a special preamble identifier and other information of fields via addressing of a specific identifier for all UEs in a cell.

Preferably, the UEs are waiting for random access response after performing random access. The other information is initial UL or access grant, or timing alignment, or temporary C-RNTI. The embodiment of the present invention can further send random access response only comprising the difference values of fields compared to or from the other information of fields respectively sent before RACH access. The preamble identifier is not presented in the difference form. The fields are of variable size or of shorter fixed size, and index, flag, or extension field is needed to indicate the number of fields, or the size of a field.

Therefore, via the process 30, the network can transmit a downlink message comprising a special preamble identifier and other information of fields via addressing of a specific identifier for all UEs in a cell.

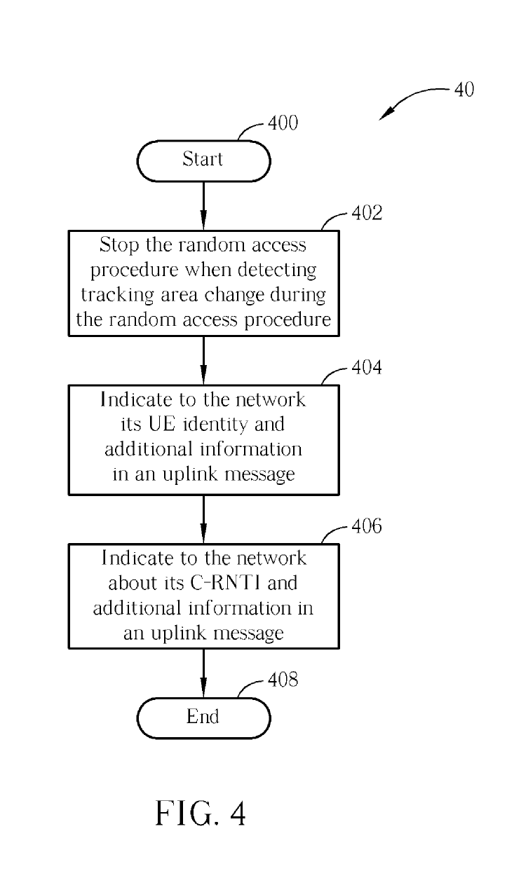

Please refer to FIG. 4, which illustrates a schematic diagram of a process 40 according an embodiment of the present invention. The process 40 is utilized for handling a random access procedure in a UE of the wireless communications system 1400, and can be compiled into the RA processing program code 220. The process 40 comprises the following steps:

Step 400: Start.

Step 402: Stop the random access procedure when detecting tracking area change during the random access procedure.

Step 404: Indicate to the network its UE identity and additional information in an uplink message.

Step 406: Indicate to the network about its C-RNTI and additional information in an uplink message.

Step 408: End.

According to the process 40, the UE stops the random access procedure when detecting tracking area change during the random access procedure, indicates to the network its UE identity and additional information in an uplink message, and indicates to the network about its C-RNTI and additional information in an uplink message.

Preferably, indicating to the network about its C-RNTI and additional information in the uplink message is indicating to network its UE identity and additional information in an uplink message after/before sending message 3 or in message 3 if message 3 is not successfully received yet.

Therefore, via the process 40, the UE stops the random access procedure when detecting tracking area change during the random access procedure, indicates to the network its UE identity and additional information in an uplink message, and indicates to the network about its C-RNTI and additional information in an uplink message.

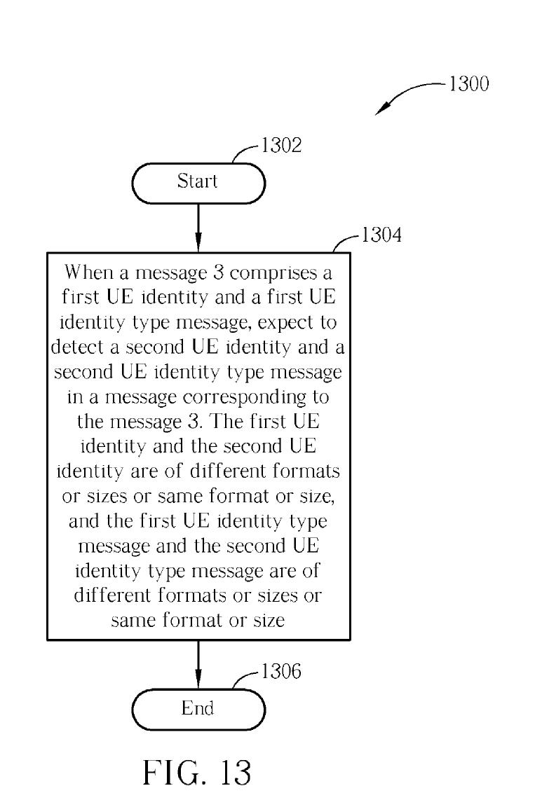

Please refer to FIG. 13, which illustrates a schematic diagram of a process 1300 according an embodiment of the present invention. The process 1300 is utilized for handling a random access procedure in a network of the wireless communications system 1400, and can be compiled into the RA processing program code 220. The process 1300 comprises the following steps:

Step 1302: Start.

Step 1304: When a message 3 comprises a first UE identity and a first UE identity type message, expect to detect a second UE identity and a second UE identity type message in a message corresponding to the message 3. The first UE identity and the second UE identity are of different formats or sizes or same format or size, and the first UE identity type message and the second UE identity type message are of different formats or sizes or same format or size.

Step 1306: End.

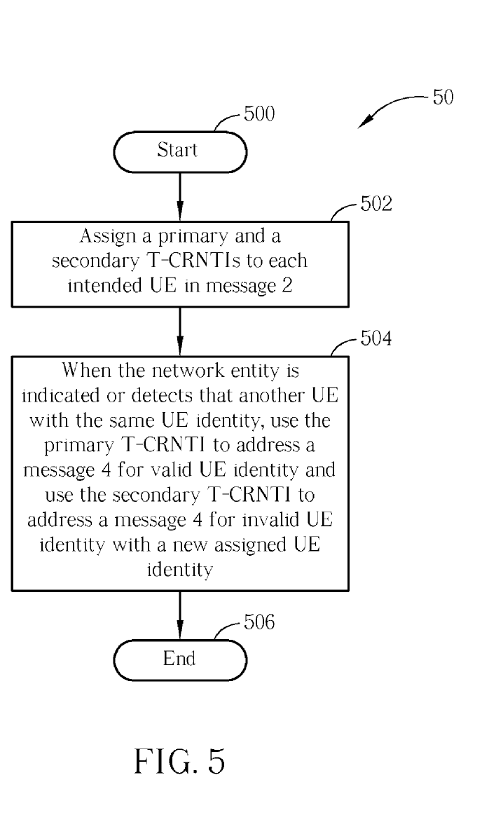

Please refer to FIG. 5, which illustrates a schematic diagram of a process 50 according an embodiment of the present invention. The process 50 is utilized for handling a random access procedure in a network of the wireless communications system 1400, and can be compiled into the RA processing program code 220. The process 50 comprises the following steps:

Step 500: Start.

Step 502: Assign a primary and a secondary T-CRNTIs to each intended UE in message 2.

Step 504: When the network is indicated or detects that another UE with the same UE identity, use the primary T-CRNTI to address a message 4 for valid UE identity and use the secondary T-CRNTI to address a message 4 for invalid UE identity with a new assigned UE identity.

Step 506: End.

According to the process 50, the network assigns a primary and a secondary T-CRNTIs to each intended UE in message 2, and when the network is indicated or detects that another UE with the same UE identity, use the primary T-CRNTI to address a message 4 for valid UE identity and use the secondary T-CRNTI to address a message 4 for invalid UE identity with a new assigned UE identity.

Preferably, the network entity is indicated or detects that another UE with the same UE identity according to a message 3.

Therefore, via the process 50, the network assigns a primary and a secondary T-CRNTIs to each intended UE in message 2, and when the network is indicated or detects that another UE with the same UE identity, use the primary T-CRNTI to address a message 4 for valid UE identity and use the secondary T-CRNTI to address a message 4 for invalid UE identity with a new assigned UE identity.

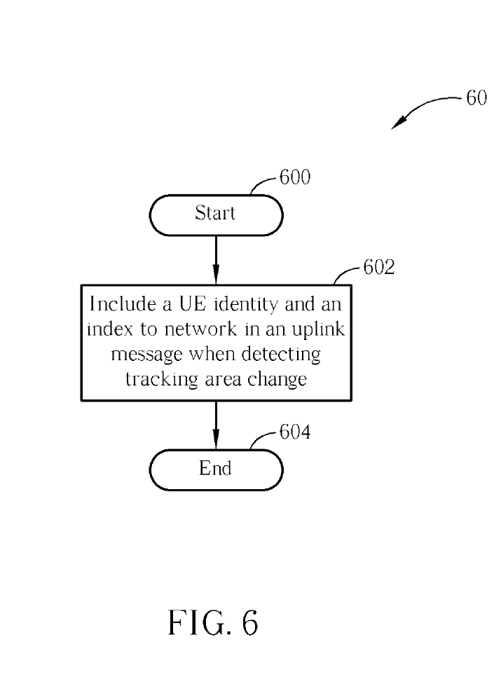

Please refer to FIG. 6, which illustrates a schematic diagram of a process 60 according an embodiment of the present invention. The process 60 is utilized for handling a random access procedure in a UE of the wireless communications system 1400, and can be compiled into the RA processing program code 220. The process 60 comprises the following steps:

Step 600: Start.

Step 602: Include a UE identity and an index to network in an uplink message when detecting tracking area change.

Step 604: End.

According to the process 60, the UE includes a UE identity and an index to network in an uplink message when detecting tracking area change.

Preferably, the index indicates whether tracking area changes, or what the original tracking area is, or whether the said UE is performing tracking area update first, or whether the said UE is by chance performing tracking area update, or what priority or service class/procedure type is. If the UE detects tracking area change before initiation random access procedure, the UE simply performs tracking area update procedure first, or perform original random access procedure with sending the said UE identity and an index in an uplink message, or perform original random access procedure with sending the said an index in an uplink message. If the UE detects tracking area change before sending a message 3 during the said random access procedure, the UE simply stops original random access procedure and perform tracking area update procedure first, or perform original random access procedure with sending the said UE identity and an index in an uplink message. If the said UE detects tracking area change after sending message 3, the UE can stop original random access procedure and simply perform tracking area update procedure, or continue uplink access with sending the said UE identity and an index in an uplink message. When the UE has a C-RNTI, the C-RNTI is used as the UE identity.

Therefore, via the process 60, the UE includes a UE identity and an index to network in an uplink message when detecting tracking area change.

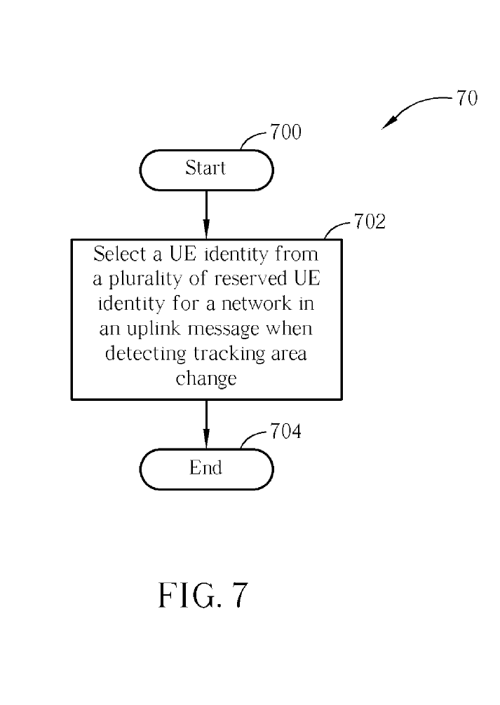

Please refer to FIG. 7, which illustrates a schematic diagram of a process 70 according an embodiment of the present invention. The process 70 is utilized for handling a random access procedure in a UE of the wireless communications system 1400, and can be compiled into the RA processing program code 220. The process 70 comprises the following steps:

Step 700: Start.

Step 702: Select a UE identity from a plurality of reserved UE identity for a network in an uplink message when detecting tracking area change (or comprising a UE identity chosen from a pool or a list of reserved UE identities in an uplink message to a network when detecting tracking area change).

Step 704: End.

According to the process 70, the embodiment of the present invention selects a UE identity from a plurality of reserved UE identity for a network in an uplink message when detecting tracking area change.

Preferably, the pool or list of reserved UE identities is updated at the network dynamically to keep the identities to be valid. After update, the pool or list is either broadcasted to UEs in the tracking area before or during random access procedure or sent in a downlink message during or after random access procedure. The uplink message is sent during or after random access procedure. After the network entity receives the said UE identity and responds to UE, the UE identity is used in contention resolution message and is removed from the said pool or the list at the said network entity and/or the said UE.

Therefore, via the process 70, the embodiment of the present invention selects a UE identity from a plurality of reserved UE identity for a network in an uplink message when detecting tracking area change.

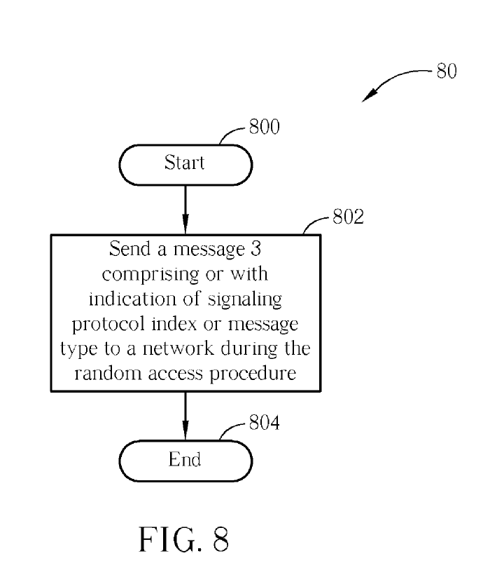

Please refer to FIG. 8, which illustrates a schematic diagram of a process 80 according an embodiment of the present invention. The process 80 is utilized for handling a random access procedure in a UE of the wireless communications system 1400, and can be compiled into the RA processing program code 220. The process 80 comprises the following steps:

Step 800: Start.

Step 802: Send a message 3 comprising or with indication of signaling protocol index or message type to a network during the random access procedure.

Step 804: End.

According to the process 80, the UE sends a message 3 comprising or with indication of signaling protocol index or message type to a network during the random access procedure.

Therefore, via the process 80, the UE sends a message 3 comprising or with indication of signaling protocol index or message type to a network during the random access procedure.

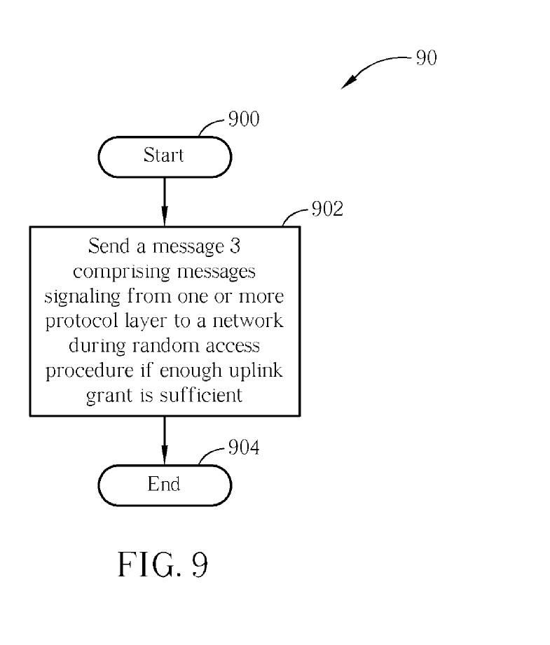

Please refer to FIG. 9, which illustrates a schematic diagram of a process 90 according an embodiment of the present invention. The process 90 is utilized for handling a random access procedure in a UE of the wireless communications system 1400, and can be compiled into the RA processing program code 220. The process 90 comprises the following steps:

Step 900: Start.

Step 902: Send a message 3 comprising messages signaling from one or more protocol layer to a network during random access procedure if enough uplink grant is sufficient.

Step 904: End.

According to the process 90, the UE sends a message 3 comprising messages signaling from one or more protocol layer to a network during random access procedure if enough uplink grant is sufficient.

Preferably, the messages or signaling from one and more protocol layer can be RRC MAC message, or initial NAS signaling or initial direct transfer messages.

Therefore, via the process 90, the UE sends a message 3 comprising messages signaling from one or more protocol layer to a network during random access procedure if enough uplink grant is sufficient.

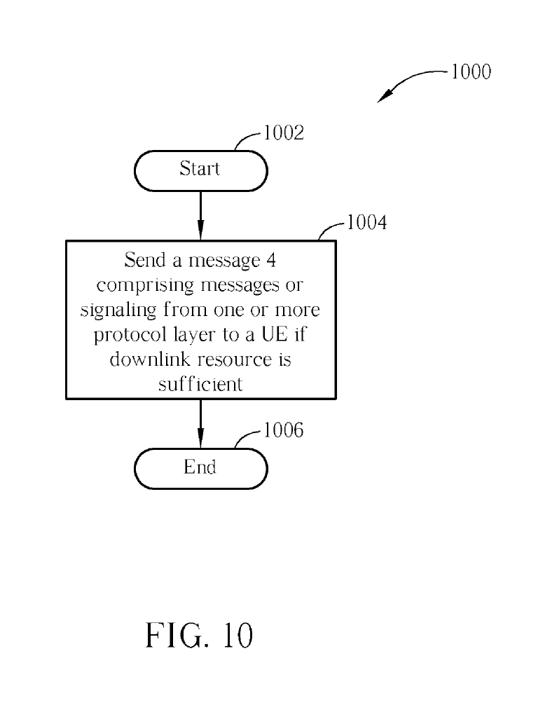

Please refer to FIG. 10, which illustrates a schematic diagram of a process 1000 according an embodiment of the present invention. The process 1000 is utilized for handling a random access procedure in a network of the wireless communications system 1400, and can be compiled into the RA processing program code 220. The process 1000 comprises the following steps:

Step 1002: Start.

Step 1004: Send a message 4 comprising messages or signaling from one or more protocol layer to a UE if downlink resource is sufficient.

Step 1006: End.

According to the process 1000, the network can send a message 4 comprising messages or signaling from one or more protocol layer to a UE if downlink resource is sufficient.

Preferably, the messages or signaling from one and more protocol layer can be RRC MAC message, or initial NAS signaling or initial direct transfer messages.

Therefore, via the process 1000, the network can send a message 4 comprising messages or signaling from one or more protocol layer to a UE if downlink resource is sufficient. The message 4 comprises an indication of signaling protocol index or message type.

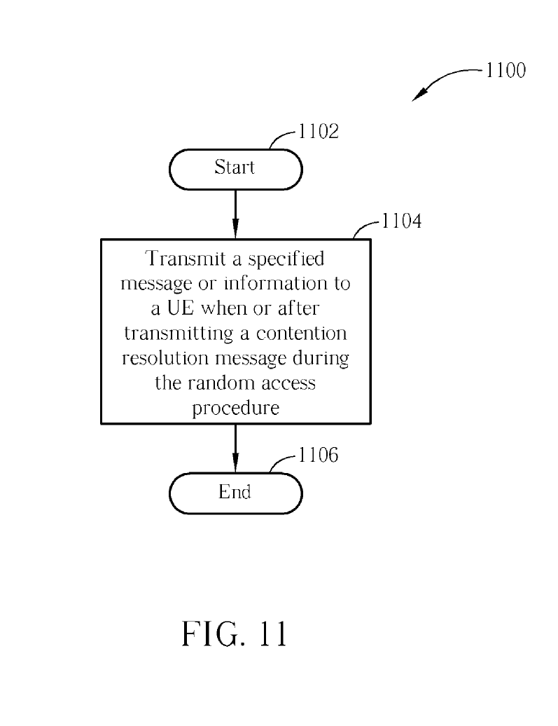

Please refer to FIG. 11, which illustrates a schematic diagram of a process 1100 according an embodiment of the present invention. The process 1100 is utilized for handling a random access procedure in a network of the wireless communications system 1400, and can be compiled into the RA processing program code 220. The process 1100 comprises the following steps:

Step 1102: Start.

Step 1104: Transmit a specified message or information to a UE when or after transmitting a contention resolution message during the random access procedure.

Step 1106: End.

According to the process 1100, the network can transmit a specified message or information to a UE when or after transmitting a contention resolution message during the random access procedure.

Preferably, the specified message comprises scheduling grant, UE identity, UE identity type.

Therefore, via the process 1100, the network can transmit a specified message or information to a UE when or after transmitting a contention resolution message during the random access procedure.

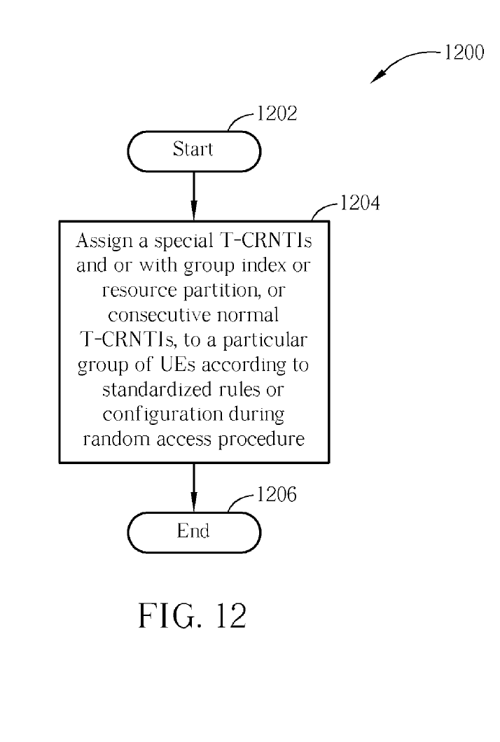

Please refer to FIG. 12, which illustrates a schematic diagram of a process 1200 according an embodiment of the present invention. The process 1200 is utilized for handling a random access procedure in a network of the wireless communications system 1400, and can be compiled into the RA processing program code 220. The process 1200 comprises the following steps:

Step 1202: Start.

Step 1204: Assign a special T-CRNTIs and or with group index or resource partition, or consecutive normal T-CRNTIs, to a particular group of UEs according to standardized rules or configuration during random access procedure.

Step 1206: End.

According to the process 1200, the network can assign a special T-CRNTIs and or with group index or resource partition, or consecutive normal T-CRNTIs, to a particular group of UEs according to standardized rules or configuration during random access procedure.

Preferably, the T-CRNTI assigned to each UE is different from other T-CRNTI. The embodiment of the present invention further assigns a special T-CRNTI with smaller size to each UE of the UE group according to the number of UE in the UE group. The T-CRNTI or the assigned group index is used to address message 4 for a UE. The group index is used once at the beginning for all UEs in the said group or used with the said T-CRNTI for each UE in the said group

Therefore, via the process 1200, the network can assign a special T-CRNTIs and or with group index or resource partition, or consecutive normal T-CRNTIs, to a particular group of UEs according to standardized rules or configuration during random access procedure.

In summary, the embodiment of the present invention provides different operations of the random access procedure, to achieve timing alignment and resource request.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling a random access procedure in a network of a wireless communications system comprising:
transmitting a downlink message comprising a special preamble identifier and other information of fields via addressing of a specific identifier for all UEs in a cell.

2. The method of claim 1, wherein the UEs are waiting for random access response after performing random access.

3. The method of claim 1, wherein other information is initial UL or access grant, or timing alignment, or temporary C-RNTI.

4. The method of claim 1, further comprising sending random access response only comprising the difference values of fields compared to or from the other information of fields respectively sent before RACH access.

5. The method of claim 4, wherein the preamble identifier is not presented in the difference form.

6. The method of claim 4, wherein the fields are of variable size or of shorter fixed size, and index, flag, or extension field is needed to indicate the number of fields, or the size of a field.

7. A method for handling a random access procedure in a user equipment, called UE hereinafter, of a wireless communications system comprising:
stopping the random access procedure when detecting tracking area change during the random access procedure;
indicating to the network its UE identity and additional information in an uplink message; or
indicating to the network about its C-RNTI and additional information in an uplink message.

8. The method of claim 7, wherein indicating to the network about its C-RNTI and additional information in the uplink message is indicating to network its UE identity and additional information in an uplink message after/before sending message 3 or in message 3 if message 3 is not successfully received yet.

9. The method of claim 7, wherein the message 3 is corresponding to a step “First scheduled Uplink transmission on uplink shared channel”.

10. A method for handling a random access procedure in a user equipment, called UE hereinafter, of a wireless communications system comprising:
when a message 3 comprises a first UE identity and a first UE identity type message, expecting to detect a second UE identity and a second UE identity type message in a message corresponding to the message 3;
wherein the first UE identity and the second UE identity are of different formats or sizes or same format or size; and
wherein the first UE identity type message and the second UE identity type message are of different formats or sizes or same format or size.

11. A method for handling a random access procedure in a network of a wireless communications system comprising:
assigning a primary and a secondary T-CRNTIs to each intended UE in message 2; and
when the network is indicated or detects that another UE with the same UE identity, using the primary T-CRNTI to address a message 4 for valid UE identity and using the secondary T-CRNTI to address a message 4 for invalid UE identity with a new assigned UE identity.

12. The method of claim 11, wherein the network entity is indicated or detects that another UE with the same UE identity according to a message 3.

13. The method of claim 11, wherein the message 4 is corresponding to a step “Contention Resolution on DL-SCH”.

14. A method for handling a random access procedure in a user equipment, called UE hereinafter, of a wireless communications system comprising:
including a UE identity and an index to network in an uplink message when detecting tracking area change.

15. The method of claim 14, wherein the index indicates whether tracking area changes, or what the original tracking area is, or whether the said UE is performing tracking area update first, or whether the said UE is by chance performing tracking area update, or what priority or service class/procedure type is.

16. The method of claim 14, wherein if the UE detects tracking area change before initiation random access procedure, the UE simply performs tracking area update procedure first, or perform original random access procedure with sending the said UE identity and an index in an uplink message, or perform original random access procedure with sending the said an index in an uplink message.

17. The method of claim 14, wherein if the UE detects tracking area change before sending a message 3 during the said random access procedure, the UE simply stops original random access procedure and perform tracking area update procedure first, or perform original random access procedure with sending the said UE identity and an index in an uplink message.

18. The method of claim 14, wherein if the said UE detects tracking area change after sending message 3, the UE can stop original random access procedure and simply perform tracking area update procedure, or continue uplink access with sending the said UE identity and an index in an uplink message.

19. The method of claim 14, wherein when the UE has a C-RNTI, the C-RNTI is used as the UE identity.

20. A method for handling a random access procedure in a user equipment, called UE hereinafter, of a wireless communications system comprising:
comprising a UE identity chosen from a pool or a list of reserved UE identities in an uplink message to a network when detecting tracking area change.

21. The method of claim 20, wherein the pool or list of reserved UE identities is updated at the network dynamically to keep the identities to be valid.

22. The method of claim 21, wherein after update, the pool or list is either broadcasted to UEs in the tracking area before or during random access procedure or sent in a downlink message during or after random access procedure.

23. The method of claim 20, wherein the uplink message is sent during or after random access procedure.

24. The method of claim 20, wherein after the network entity receives the said UE identity and responds to UE, the UE identity is used in contention resolution message and is removed from the said pool or the list at the said network entity and/or the said UE.

25. A method for handling a random access procedure in a user equipment, called UE hereinafter, of a wireless communications system comprising:
sending a message 3 comprising or with indication of signaling protocol index or message type to a network during the random access procedure.

26. The method of claim 25, wherein the message 3 is corresponding to a step “First scheduled Uplink transmission on uplink shared channel”.

27. A method for handling a random access procedure in a user equipment, called UE hereinafter, of a wireless communications system comprising:
sending a message 3 comprising messages or signaling from one or more protocol layer to a network during random access procedure if enough uplink grant is sufficient.

28. The method of claim 27, wherein the message 3 is corresponding to a step “First scheduled Uplink transmission on uplink shared channel”.

29. The method of claim 27, wherein the messages or signaling from one and more protocol layer can be RRC MAC message, or initial NAS signaling or initial direct transfer messages.

30. A method for handling a random access procedure in a network of a wireless communications system comprising:
sending a message 4 comprising messages or signaling from one or more protocol layer to a UE if downlink resource is sufficient.

31. The method of claim 30, wherein the message 4 is corresponding to a step “Contention Resolution on DL-SCH”.

32. The method of claim 30, wherein the messages or signaling from one and more protocol layer can be RRC MAC message, or initial NAS signaling or initial direct transfer messages.

33. The method of claim 30, wherein the message 4 comprises an indication of signaling protocol index or message type.

34. A method for handling a random access procedure in a network of a wireless communications system comprising:
transmitting a specified message or information to a UE when or after transmitting a contention resolution message during the random access procedure.

35. The method of claim 34, wherein the specified message comprises scheduling grant, UE identity, UE identity type.

36. A method for handling a random access procedure in a network of a wireless communications system comprising:
assigning a special T-CRNTIs and or with group index or resource partition, or consecutive normal T-CRNTIs, to a particular group of UEs according to standardized rules or configuration during random access procedure.

37. The method of claim 36, wherein the T-CRNTI assigned to each UE is different from other T-CRNTI.

38. The method of claim 36, further comprising assigning a special T-CRNTI with smaller size to each UE of the UE group according to the number of UE in the UE group.

39. The method of claim 36, wherein the T-CRNTI or the assigned group index is used to address message 4 for a UE.

40. The method of claim 39, wherein the message 4 is corresponding to a step “Contention Resolution on DL-SCH”.

41. The method of claim 39, wherein the group index is used once at the beginning for all UEs in the said group or used with the said T-CRNTI for each UE in the said group.

42. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
transmitting a downlink message comprising a special preamble identifier and other information of fields via addressing of a specific identifier for all UEs in a cell.

43. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
stopping the random access procedure when detecting tracking area change during the random access procedure;
indicating to the network its UE identity and additional information in an uplink message; or
indicating to the network about its C-RNTI and additional information in an uplink message.

44. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
when a message 3 comprises a first UE identity and a first UE identity type message, expecting to detect a second UE identity and a second UE identity type message in a message corresponding to the message 3;
wherein the first UE identity and the second UE identity are of different formats or sizes or same format or size; and
wherein the first UE identity type message and the second UE identity type message are of different formats or sizes or same format or size.

45. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
assigning a primary and a secondary T-CRNTIs to each intended UE in message 2; and
when the network is indicated or detects that another UE with the same UE identity, using the primary T-CRNTI to address a message 4 for valid UE identity and using the secondary T-CRNTI to address a message 4 for invalid UE identity with a new assigned UE identity.

46. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
including a UE identity and an index to network in an uplink message when detecting tracking area change.

47. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
comprising a UE identity chosen from a pool or a list of reserved UE identities in an uplink message to a network when detecting tracking area change.

48. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
sending a message 3 comprising or with indication of signaling protocol index or message type to a network during the random access procedure.

49. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
sending a message 3 comprising messages or signaling from one or more protocol layer to a network during random access procedure if enough uplink grant is sufficient.

50. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
sending a message 4 comprising messages or signaling from one or more protocol layer to a UE if downlink resource is sufficient.

51. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
transmitting a specified message or information to a UE when or after transmitting a contention resolution message during the random access procedure.

52. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
assigning a special T-CRNTIs and or with group index or resource partition, or consecutive normal T-CRNTIs, to a particular group of UEs according to standardized rules or configuration during random access procedure.
